(19) United States
(12) Patent Application Publication
(10) Pub. No.: US 2014/0113029 A1
(43) Pub. Date: Apr. 24, 2014

(54) EXTENDED SHELF LIFE SANDWICH AND METHOD OF MAKING SAID SANDWICH

(71) Applicant: HORMEL FOODS CORPORATION, Austin, MN (US)

(72) Inventors: Ryan R. Timm, Adams, MN (US); Tami M. Langstaff, Austin, MN (US); Steven L. Corkill, Austin, MN (US)

(73) Assignee: HORMEL FOODS CORPORATION, Austin, MN (US)

(21) Appl. No.: 14/056,439

(22) Filed: Oct. 17, 2013

Related U.S. Application Data
(60) Provisional application No. 61/715,507, filed on Oct. 18, 2012.

(51) Int. Cl. A23B 4/033; A23L 1/00; A23B 4/12

(52) U.S. Cl. CPC A23B 4/033; A23B 4/12; A23L 1/0067
USPC 426/55; 426/332; 426/92

(57) ABSTRACT

An extended shelf life sandwich and a method of forming the sandwich is provided. The method includes processing meat to be used in the sandwich. The processing includes: applying a humectant to a meat; acidulating the meat; drying the meat until a water activity of no less than 0.85 is achieved. The process is completed by wrapping the processed meat into a bread-type product.

### BACKGROUND

The challenge for the inventors was to develop a refrigerated, preassembled, multi-component food system made with high water activity food components that would be pleasing to the palate yet safe to consume over an extended shelf life. A product's shelf life is the length of time a product may be stored without becoming unsuitable for consumption. It is desirable to extend the shelf life of a consumable product to account for the time it takes to (1) ship the product to a retailer, (2) sell the product to a consumer once it is at the retailer's location and (3) for the consumer to consume the product. However, the product must maintain a flavor and texture that is acceptable to consumers to be commercially successful.

In order to develop a consumer-accepted product (i.e. flavorful, acceptable texture, visually appealing, etc.), the sandwich components must possess a water activity and moisture content that consumers would expect in a sandwich for the entire shelf life of the product. If the components contain too much moisture, the sandwich would become soggy in a very short period of time. Moreover, with the increase in water activity comes the increased risks of food safety hazards. In contrast, if the components do not contain enough moisture, the sandwich would be dry.

In regards to food safety, Chapter 3 of the United States Food & Drug Administration (US FDA) Food Code states food packaged under reduced oxygen conditions must have a shelf life less than 14 days for a refrigerated product due to the concern of Clostridium botulinum unless additional food safety hurdles are used. In addition, the United Stated Department of Agriculture Food Safety Inspection Service (USDA FSIS) states ready-to-eat (RTE) products should show no more than a 2-log₁₀ growth of Listeria monocytogenes over the shelf life of a product.

For the reasons stated above and for other reasons stated below which will become apparent to those skilled in the art upon reading and understanding the present specification, there is a need in the art to develop a preassembled, multi-component food system made with high water activity food components with an extended shelf life.

### SUMMARY OF INVENTION

The above-mentioned problems of current systems are addressed by embodiments of the present invention and will be understood by reading and studying the following specification. The following summary is made by way of example and not by way of limitation. It is merely provided to aid the reader in understanding some of the aspects of the invention.

In one embodiment, a method of forming a sandwich with a long shelf life is provided. The method includes, processing meat to be used in a sandwich. The processing includes: applying a humectant to a meat; acidulating the meat; drying the meat until a water activity of no less than 0.85 is achieved; and wrapping the processed meat in an outer carrier.

In another embodiment, a method of forming a wrap-like sandwich is provided. This comprises: preparing meat for use; mixing ingredients including a humectant with the meat to form a meat product; acidulating the meat product; drying the acidulated meat product until a water activity of no less than 0.85 is achieved; slicing the meat product; and wrapping the meat product in an edible outer carrier.

In still another embodiment, a wrap-like sandwich for human consumption is provided. The wrap-like sandwich includes an edible outer carrier and a filling The filling is received in the outer carrier. The filling includes a meat product having a water activity of no less than 0.85.

In yet another embodiment, a wrap-like sandwich for human consumption having a shelf life greater than 14 days is provided. The wrap like sandwich includes filling and a flat bread. The filling includes a humectant and acidulated and dried meat having a water activity of no less than 0.85. The flat bread encases the filling.

### BRIEF DESCRIPTION OF THE DRAWINGS

The present invention can be more easily understood and further advantages and uses thereof will be more readily apparent, when considered in view of the detailed description and the following figures in which:

FIG. 1 is a generic moisture sorption isotherm graph of the prior art;

FIG. 2 is an illustration of a wrap-type sandwich of one embodiment;

FIG. 3 is a sandwich formation flow diagram of an embodiment of the present invention;

FIG. 4A is a table illustrating the results of a sensory evaluation panel relating to ham;

FIG. 4B is a table illustrating the results of a sensory evaluation panel relating to turkey;

FIG. 5 is a graph illustrating the water activity;

FIG. 6 is a table illustrating the appearance evaluations;

FIG. 7 is a table illustrating moistness evaluations;

FIG. 8 is a table illustrating acceptable shelf life;

FIG. 9 is a table illustrating Clostridium botulinum toxin results;

FIG. 10 is a graph illustrating Bacillus cereus growth; and

FIG. 11 is a graph illustrating Listeria monocytogenes growth;

In accordance with common practice, the various described features are not drawn to scale but are drawn to emphasize specific features relevant to the present invention. Reference characters denote like elements throughout figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that changes may be made without departing from the spirit and scope of the present invention. The following detailed description is, therefore, not to be taken in a limiting sense, and the scope of the present invention is defined only by the claims and equivalents thereof.

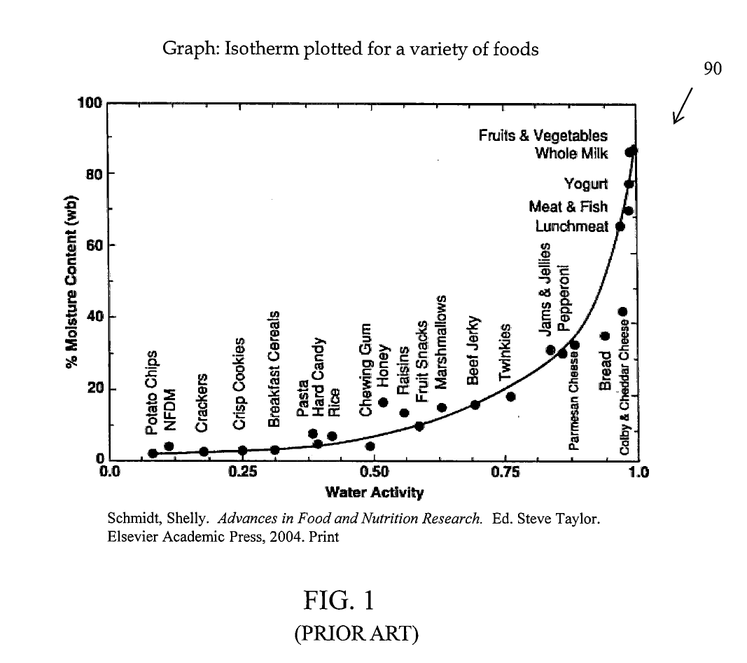

In order to produce a refrigerated, assembled, multi-component wrap-type sandwich product with a shelf life of longer than 14 days, the rate of moisture migration between the components must be controlled to maintain food safety and product quality. This is especially true in multi-component products where one or more of the components has a higher water activity and percent moisture than other component such as meat (higher water activity) in a sandwich containing meat and bread. FIG. 1 is a prior art diagram of a generic moisture sorption isotherm graph 90 that shows the relationship between water activity and moisture content for various food types. In FIG. 1, foods, such as crackers and cookies are found on a different point on the isotherm curve compared to meat, dairy and bread. Because the “snack-type” foods are located on the more horizontal slope of the isotherm, water activity is the most crucial variable in controlling moisture migration in a multi-component system since water activity can greatly change without changing moisture content. Since the components in this invention are located on the more vertical slope of the isotherm, moisture content, along with water activity, must also be considered for controlling the rate of moisture migration. Currently in the market place, in order to obtain a greater than 14 day shelf life on high water activity food components, each component must be packaged separately to prevent the problem of moisture migration between components. Embodiments of the present invention provide a method of preparing meats, such as, but not limited to, poultry, beef, pork and fish, to slow the migration of moisture between the meats and an outer carrier such as, but not limited to, a flat bread in a wrap-type sandwich type product so that an acceptable shelf life of more than 14 days can be achieved. Moreover, with embodiments, a shelf life of at least 60 days is possible. Typical moisture content of traditional ham ranges from 70% to 75% moisture (water activity of approx. 0.97 to 0.99) while the typical moisture content of flat bread ranges from 32% to 36% moisture (water activity of approx. 0.93 to 0.96). Thus, the moisture moves from the higher water activity product (ham) into the lower water activity product (flat bread). This equalization of water activity will result in a large increase in moisture level on the surface of the bread thus creating an undesirable, soggy, doughy texture. In embodiments, slowing the migration of moisture is accomplished by applying humectants and an acidulation process to the meat before it is assembled in the wrap-type sandwich to reduce the moisture in the meat. By using acidulation and humectants on the meat, the moisture content of the meat is reduced to approximately 60% or less and having a water activity of no less than 0.85. At this reduced water activity, the meat does not cause the outer carrier to become unacceptable in quality for an extended period of time in refrigerated storage.

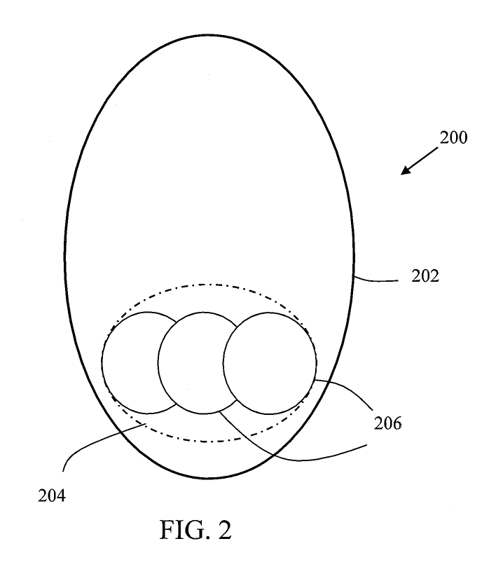

An example cross-sectional illustration of a formed wrap-like sandwich of one embodiment is shown in FIG. 2. The wrap-like sandwich 200 includes filling housed by an outer carrier 202. The outer carrier 202 is an edible product such as, but not limited to, a baked flour-containing product. An example outer carrier is a flat bread as discussed above. The filling in embodiments includes the meat product 206 that has been processed with a humectant, acidulation and dried as described below. The filling in this embodiment also includes cheese 204. In embodiments, the moisture migration has been controlled by regulation of water activity and moisture levels within tight ranges in each of the individual components, so that when combined into a sandwich a low level of moisture migration between components is achieved to provide an acceptable quality product with greater than 60 days shelf life.

The process as set out above, creates a meat product that is closer in water activity and percent moisture to the other components (bread, cheese, etc.), which lowers the driving force for water diffusion thus reducing the rate of moisture migration between the components. In order to create a safe product with a shelf life longer than 14 days, the inventors used a combination of strategies (i.e. “hurdles”). In addition to reduced water activity of the meats, cheeses, and flat breads other hurdles include: (1) adding humectants and acidulating the meat, (2) adding preservatives known in the art and (3) using controlled atmosphere packaging and refrigeration. Unexpectedly, even with the use of hurdles to create a safe product, the inventors were still able to create a product in which organoleptic properties (i.e. flavor and texture) were acceptable to consumers.

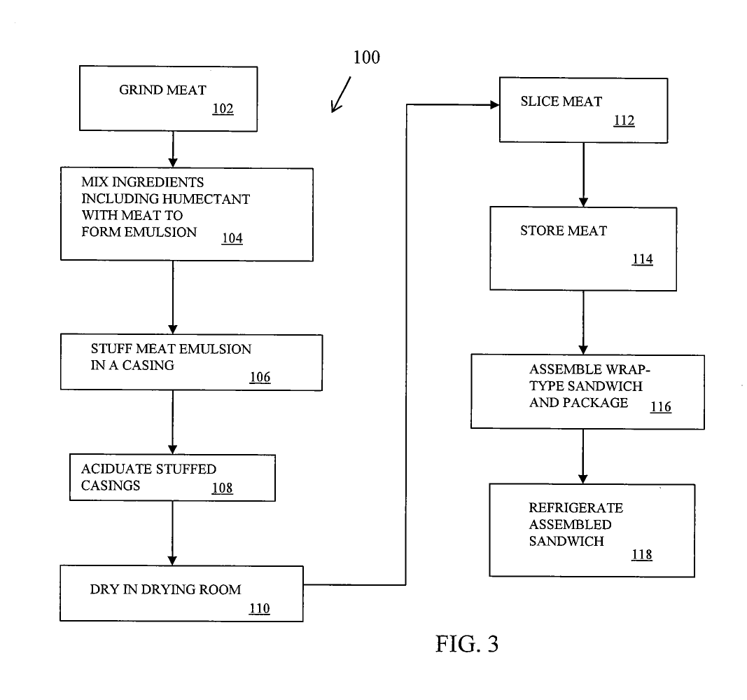

Referring to FIG. 3, an example flow diagram of making a sandwich of one embodiment is provided. In the embodiment of FIG. 3 the process starts by grinding the meat (102). In one embodiment the meat is ground to less than an inch thick and in another embodiment, the meat is ground to approximately ⅜ of an inch thick. In other embodiments the meat is not ground, rather, processed as intact muscles. The meat is then mixed with ingredients (104). The ingredients could include flavoring ingredients such as, but not limited to, salt and sweeteners. The ingredients could also include curing ingredients such as, but not limited to, Sodium Nitrite, Sodium Erythrobate and Ascorbic Acid. The ingredients also include a humectant as discussed above. An example humectant used in one embodiment is honey. Honey contains natural sugars that retain moisture within the meat. Honey also increases sweetness while reducing bitterness caused by acidulation. Other types of humectants can be used such as, but not limited to, Sorbitol, Glycerin, Propylene Glycol, Manitol, Sugar Alcohols, Gum Acacia, and invert sugar.

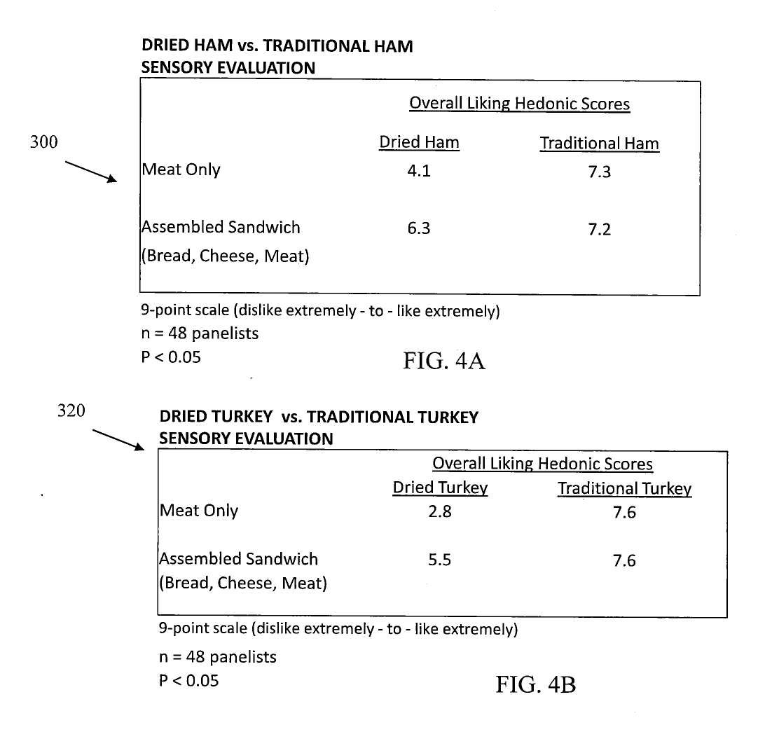

Once the ingredients are mixed with the meat (104), the meat product (emulsion) is stuffed into a casing (106). Other methods of containing the meat product can be used. The stuffed casings are then acidulated (108). Acidulation makes the meat product slightly acidic. In one embodiment, the acidulation of the stuffed casings is accomplished by fermenting and then cooking the stuffed casings in a heat processing oven such as, but not limited to, a smokehouse or steam house. In other embodiments, a chemical acidulation process is used to acidulate the meat. Traditional meats, such as ham and turkey, are not acidulated since the acidulation adversely affects the flavor of the meat. The inventors conducted a sensory evaluation panel that included 48 panelists. The sensory evaluation panel compared traditional water added ham versus a ham formulated with humectants and acidulation (dried ham). Using a 9 point scale going from dislike extremely at 1 to like extremely at 9, the traditional ham received an overall liking score of 7.3 while the dried ham had an overall liking score of 4.1 (slightly dislike). When sandwiches were made using traditional ham and the dried ham, the overall liking score for the sandwich made with traditional ham was 7.2 while the overall liking score of the sandwich made with dried ham was a more acceptable 6.3 (slightly like). Unexpectedly, when the invented (dried) ham was combined with the ingredients in the sandwich, the sandwich received an overall score that was likable by the panel. Similar results were found when traditional turkey was compared to turkey formulated with humectants and acidulation. The results of the sensory evaluation panel for the ham are in table 300 of FIG. 4A and the results of the sensory evaluation panel for turkey are in table 320 of FIG. 4B. In the results of both comparisons, a P value of less than 0.05 is present. A P<0.05 means there is a less than five percent chance the results are due to chance alone.

After acidulation/cooking, the stuffed casings are placed in a dry room at approximately 60° F. and 60% relative humidity (110). The stuffed casings remain in the dry room until a desired water activity is achieved. In one embodiment, the desired water activity is around 0.85. In one embodiment, the desired water activity is no less than 0.85. The water activity of traditional ham and turkey is higher than 0.97. Water activity is a measure of the energy of the water in a food which can be an indicator of the possibility of microbial growth. Pure water has a water activity of 1.0 which is the highest water activity possible, while processed meats are generally in the range of 0.97 to 0.99. In another embodiment, the casings remain in the dry room until a desired water activity of no less than 0.85 is achieved. Moreover, in one embodiment, the desired water activity is 0.85. Once the desired water activity level is achieved, the casings are removed from cooked meat, sliced, (112) and then stored until use (114). The sliced meat product is then assembled in a wrap-type sandwich, packaged (116) and then remains refrigerated through distribution and retail sales (118) until the consumer purchases and consumes the sandwich prior to the “use or freeze by date”. As discussed above, processing the meat in this fashion results in an extended shelf life product. In fact, the shelf life will exceed the 14 day guideline set out for such types of products because of a concern for Clostridium botulinum as stated in Chapter 3 of the United States Food and Drug Administration (US FDA) Food Code. In addition, the United Stated Department of Agriculture Food Safety Inspection Service (USDA FSIS) states ready-to-eat (RTE) products should show no more than a 2-log₁₀ growth of Listeria monocytogenes over the shelf life of a product. Inventors conducted microbial challenge studies for Clostridium botulinum, Listeria monocytogenes, and Bacillus cereus on such sandwiches as discussed below. When the sandwiches are packaged in a controlled atmosphere package using a blend of nitrogen and carbon dioxide and stored at refrigeration temperatures there is no risk for growth of these pathogens over a period of at least 60 days.

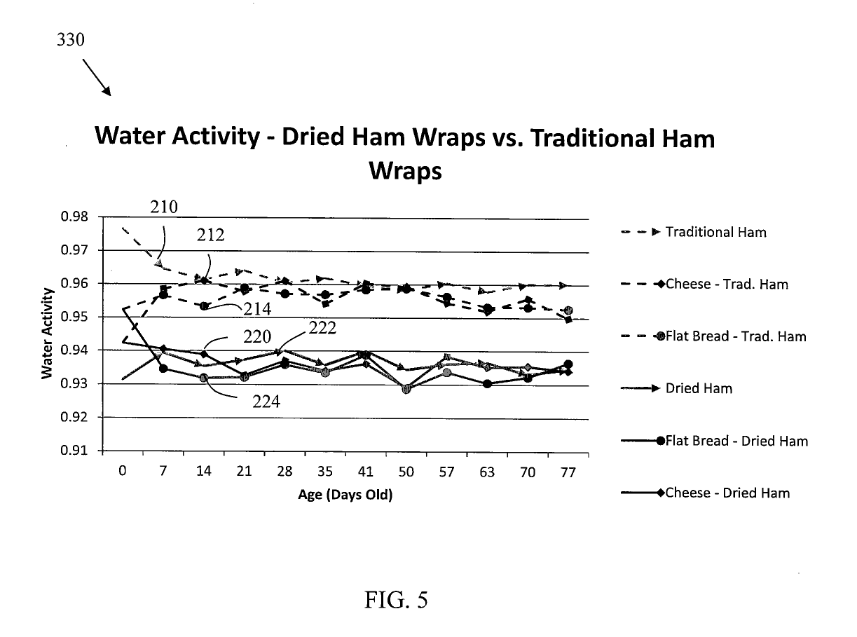

Referring to FIG. 5, a plot (330) of the water activity of the individual sandwich components as a function of storage time at refrigerated temperatures after packaging is provided. The graph illustrates the change in water activity in the ingredients of a wrap-like sandwich with its meat processed as discussed above vs. a traditional meat in a wrap-like sandwich over time. The wrap-like sandwich in this comparison includes ham, cheese and flat bread. In particular, graph 330 illustrates with a traditional sandwich, the ham (the traditional ham data is designated as 210 in graph 330) starts out with a water activity of about 0.976, the cheese (cheese data in the traditional sandwich is designated 212 in the graph 330) starts out with a water activity of about 0.942 and the bread (bread data in the traditional sandwich is designated as 214 in the graph) starts out with a water activity of about 0.952. As illustrated, as time passes, the moisture from the ham 210 migrates into the cheese 212 and bread 214 resulting in their water activities rising. As the graph illustrates, in the traditional sandwich at day 77, the water activity of the ham 210 is down to about 0.96 while the water activity of the cheese 212 has risen to about 0.95 and the water activity of the bread 214 has risen to about 0.951. In the dried ham sandwich, the water activity of the ham (the dried ham data is designated as 222 in graph 330) at the beginning is about 0.93. Although the cheese (the cheese data in the dried ham sandwich is designated as 220 in graph 330) and bread (the bread data is designated as 224 in the dried ham sandwich of graph 330) start off with the same water activitiy as the cheese 212 and bread 214 of the traditional sandwich, on day 77, the water activity of the ham 222, the cheese 220 and the bread 224 are all about 0.935 within about 14 days. This is significantly less than the water activity of the components of the traditional sandwich. Hence, the processing of the meat to reduce its moisture content as discussed above, allows the water activity of the cheese 220 and bread 224 to remain constant in the sandwich after a period of about 14 days as compared to a traditional sandwich. And importantly, the resulting wrap-like sandwiches with reduced water activity and moisture are satisfactory when eaten.

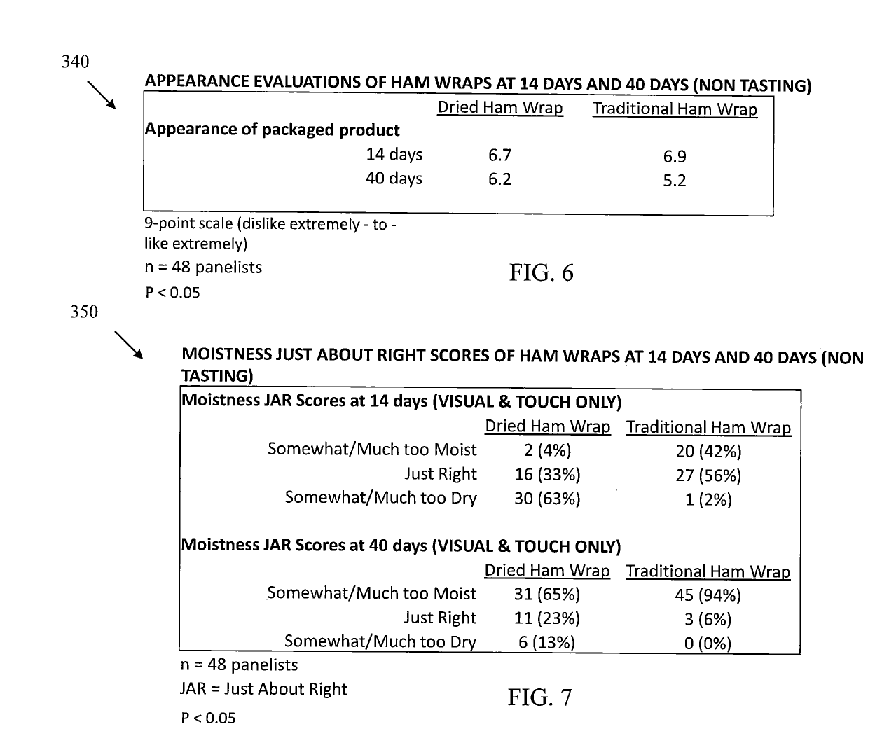

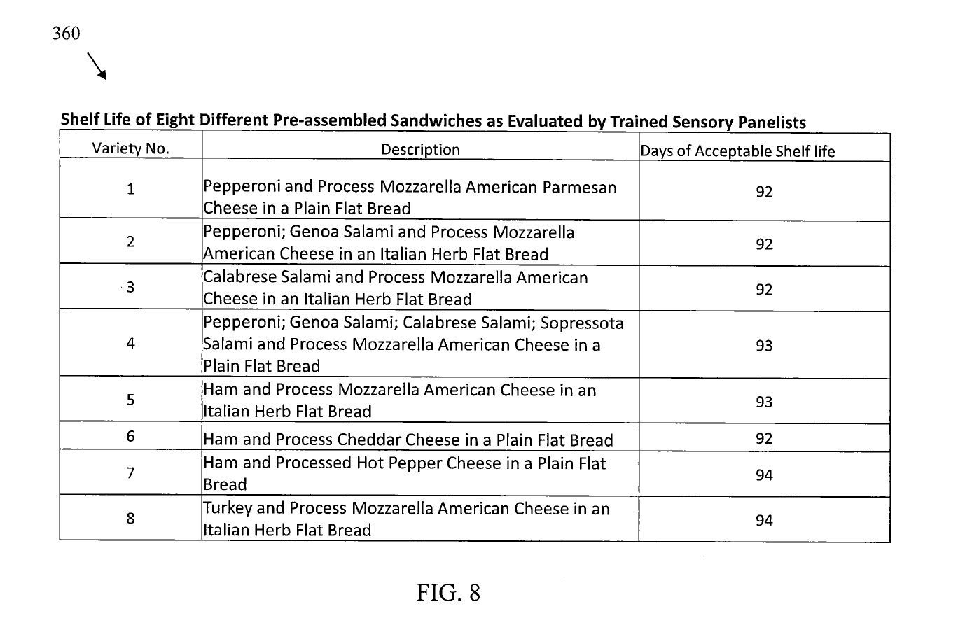

Table 340 (FIG. 6) contains the results of the visual (appearance) examination of the invented wrap (dried ham) vs. conventional wrap (traditional ham). Table 340 contains the averaged results of a visual examination using a panel of 48 people relating the appearance of a packaged dried ham wrap-like sandwich and a packaged traditional ham wrap-like sandwich at 14 days and 40 days, stored at 4° C. Using a 9 point scale going from dislike extremely (score of 1) to like extremely (score of 9) the panel provided data that was averaged. As illustrated, at day 14 the panelists provided an average score of 6.7 to the dried ham wrap-like sandwich and 6.9 score to the traditional wrap-like sandwich. Hence, at 14 days the scores were not significantly different and were fully acceptable. At day 40 the panelists provided an average score of 6.2 for the dried ham wrap-like sandwich and a significantly lower average score of 5.2 for the traditional ham wrap-like sandwich. Hence, the score for the dried ham wrap-like sandwich only dropped 0.5 units in appearance over the time period while the traditional ham wrap-like sandwich dropped 1.7 units over the time period. In addition the same panel was asked to feel the product and choose the degree of moistness of the outside of the wrap (flat bread), again for invented wrap vs. the conventional wrap at the two different storage periods. The moistness table 350 of FIG. 7 illustrates a moistness “Just About Right” (JAR) score of the dried ham wrap-like sandwich and the traditional ham wrap-like sandwich at 14 days and 40 days. Using the three scoring categories the number is the percentage of panelists choosing that score category. The data for the dried ham wrap-like sandwich is in the left column and the data for the traditional ham wrap-like sandwich is in the right column. As illustrated, at 14 days 63% of the panelists polled thought the dried ham wrap-like sandwich was somewhat/much too dry and 56% of the panelists polled thought the traditional ham wrap-like sandwich moisture was just right. At 40 days, 65% of the panelists thought the dried ham wrap-like sandwich was somewhat/much too moist while 94% of the panelists polled thought the traditional ham wrap-like sandwich was too moist. Table 360 in FIG. 8 illustrates the longest acceptable sensory shelf life at refrigerated storage as determined by ten trained sensory panelists. They examined eight different pre-assembled sandwiches processed as described above. The variety of the sandwiches included: pepperoni and process mozzarella American parmesan cheese in a plain flat bread (variety 1); pepperoni; Genoa salami and process mozzarella American cheese in an Italian herb flat bread (variety 2); Calabrese salami and process mozzarella American cheese in an Italian herb flat bread (variety 3), pepperoni; Genoa salami; Calabrese salami; Sopressota salami and process mozzarella American cheese in a plain flat bread (variety 4); ham and process mozzarella American cheese in an Italian herb flat bread (variety 5); ham and process cheddar cheese in a plain flat bread (variety 6); ham and processed hot pepper cheese in a plain flat bread (variety 7); and turkey and process mozzarella American cheese in an Italian herb flat bread (variety 8). As illustrated in table 360, each of the different varieties of packaged sandwiches has an acceptable sensory shelf life of over 90 days.

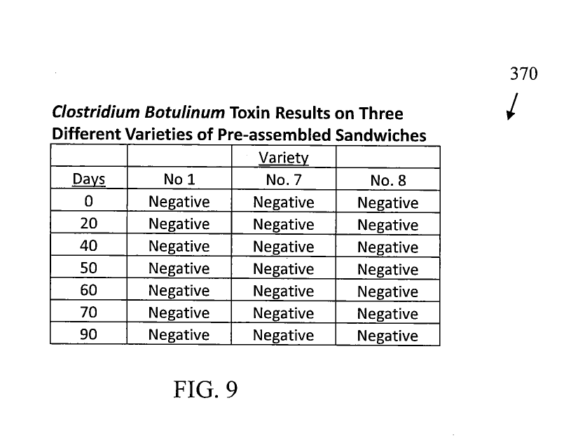

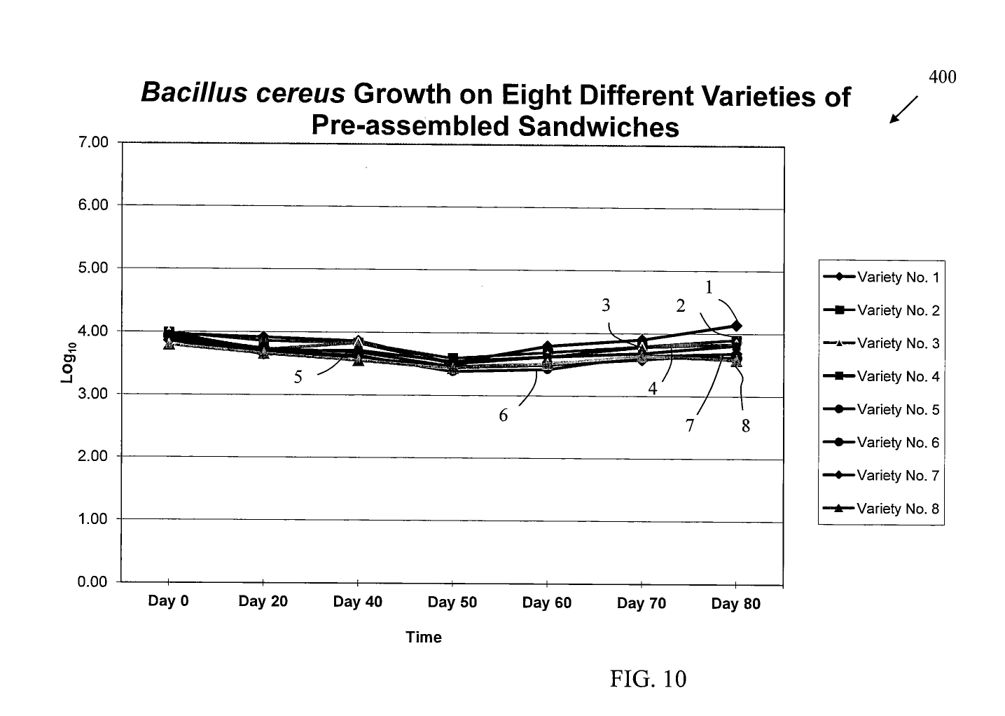

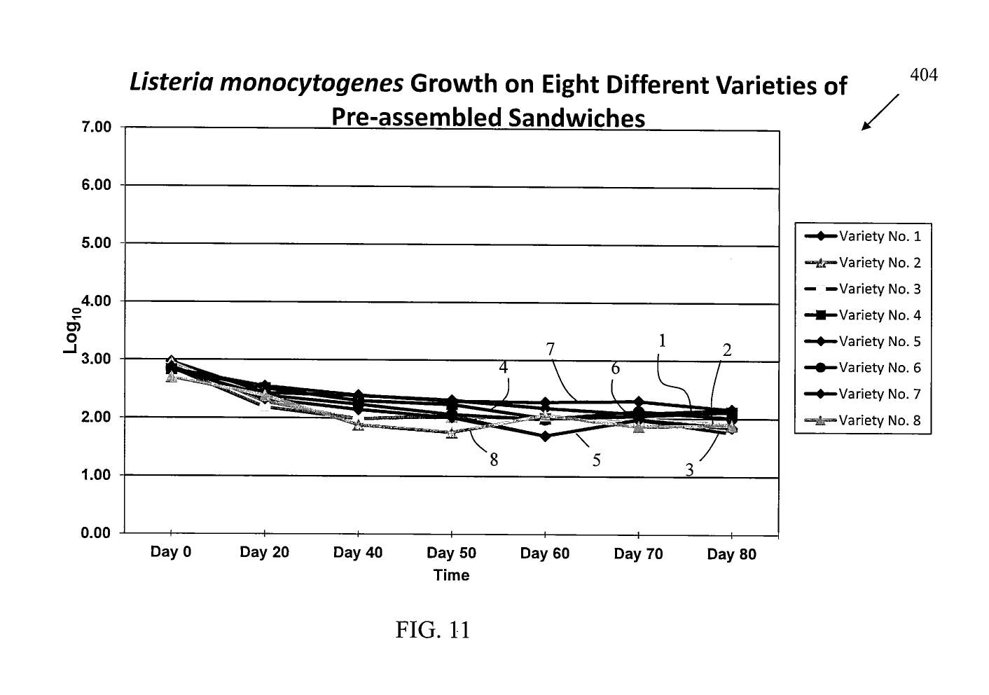

As discussed briefly above, microbial challenge studies for Clostridium botulinum, Listeria monocytogenes, and Bacillus cereus (all three bacterial pathogens) were conducted on sandwiches using this invention. For example, for Clostridium botulinum, the sandwiches were inoculated with a target of 100 spores per gram and toxin formation was evaluated using the mouse bioassay over a 90 day period at 12° C. Study results for Clostridium botulinum for three different varieties of wrap sandwiches are shown in table 370 of FIG. 9. Table 370 indicates that the three different varieties of wrap-like sandwiches tested negative for Clostridium botulinum toxin up to 90 days after assembly. The three varieties include: a pepperoni and process mozzarella American parmesan cheese in a plain flat bread (variety 1); ham and processed hot pepper cheese in a plain flat bread (variety 7); and turkey and process mozzarella American cheese in an Italian herb flat bread (variety 8). Referring to FIG. 10, a study on Bacillus cereus growth is provided on the 8 different varieties of sandwiches (as described in FIG. 8). In particular, FIG. 10 illustrates measured Bacillus cereus growth for each variety of sandwich on day 0, day 20, day 40, day 50, day 60, day 70 and day 80. The test samples were inoculated with a target of 1,000 cfu/gram (3.0 log₁₀ cfu/gram). As illustrated, the Bacillus cereus growth in each of the variety of sandwiches (1-8), processed as discussed above, is minimal over the span of 80 days. Moreover, the amount of Bacillus cereus growth is well below the criteria of a three log increase as stated in the report written by the Institue of Food Technologists entitled “Evaluation and Definition of Potentially Hazardous Foods.” A study of Listeria monocytogenes growth on the different varieties of sandwiches (1-8) is shown in FIG. 11. FIG. 11 illustrates measured Listeria monocytogenes growth levels in the variety of sandwiches (1-8) on day 0, day 20, day 40, day 50, day 60, day 70 and day 80. As illustrated, as time passes, the Listeria monocytogenes growth actually decreases in the sandwiches processed as discussed above.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A method of forming a sandwich with a long shelf life, the method comprising:
processing meat to be used in a sandwich, the processing including,
applying a humectant to a meat;
acidulating the meat;
drying the meat until a water activity of no less than 0.85 is achieved; and
wrapping the processed meat in an outer carrier.

2. The method of claim 1, further comprising:
grinding up the meat; and
stuffing the ground meat and humectant into a casing before acidulating.

3. The method of claim 2, further comprising:
slicing the meat after the meat is dried.

4. The method of claim 1, wherein applying a humectant to a meat further comprises:
applying honey to the meat.

5. The method of claim 1, wherein applying a humectant to meat further comprises:
applying at least one of Sorbitol, Glycerin, Propylene Glycol, Manitol, Sugar Alcohols, Gum Acacia, and invert sugar to the meat.

6. The method of claim 1, wherein acidulating the meat further comprises:
fermenting the meat.

7. The method of claim 1, further comprises:
acidulating the meat in a heat processing oven.

8. The method of claim 7, further comprising:
cooking the meat in a heat processing oven.

9. The method of claim 1, wrapping the processed meat in an outer carrier further comprises:
wrapping the meat in a baked flour-containing product.

10. The method of claim 1, wrapping the processed meat in an outer carrier further comprises:
wrapping the meat in a flat bread.

11. The method of claim 1, further comprising:
adding ingredients to the meat.

12. The method of claim 1, wherein the meat is at least one of poultry, beef, pork and fish.

13. The method of claim 1, wherein the shelf life of the sandwich extends beyond 14 days.

14. The method of claim 1, wherein the sandwich has an acceptable flavor and texture for human consumption.

15. A method of forming a wrap-like sandwich comprising:
preparing meat for use;
mixing ingredients including a humectant with the meat to form a meat product;
acidulating the meat product;
drying the acidulated meat product until a water activity of no less than 0.85 is achieved;
slicing the meat product; and
wrapping the meat product in an edible outer carrier.

16. The method of claim 15, wherein preparing the meat further comprises:
grinding the meat.

17. The method of claim 16, wherein grinding the meat further comprises:
grinding the meat to pieces under 1 inch.

18. The method of claim 15, wherein acidulating the meat product further comprises:
fermenting the meat product.

19. The method of claim 15, further comprising:
acidulating the meat product in a heat processing oven.

20. The method of claim 15, further comprising:
stuffing the meat product into a casing before acidulating.

21. The method of claim 15, wherein a shelf life of the wrap-like sandwich is greater than 14 days.

22. A wrap-like sandwich for human consumption comprising:
an edible outer carrier; and
filling received in the outer carrier, the filling including an acidulated meat product having a water activity of no less than 0.85.

23. The wrap-like sandwich of claim 22, wherein the outer carrier is a flat bread.

24. The wrap-like sandwich of claim 22, wherein the meat product was further cooked, dried and mixed with a humectant.

25. The wrap-like sandwich of claim 24, wherein the humectant is at least one of honey, Sorbitol, Glycerin, Propylene, Glycol, Manitol, Sugar Alcohols, Gum Acacia, and invert sugar.

26. A wrap-like sandwich for human consumption having a shelf life greater than 14 days, comprising:
a filling including,
a humectant, and
acidulated and dried meat having a water activity of no less than 0.85; and
a flat bread encasing the filling.

27. The method of claim 26, wherein the wrap-like sandwich has an acceptable flavor and texture for human consumption.
